(19) United States
(12) Patent Application Publication
(10) Pub. No.: US 2022/0396125 A1
(43) Pub. Date: Dec. 15, 2022

(54) VEHICLE GLAZING

(71) Applicant: Central Glass Company, Limited, Ube-shi, Yamaguchi (JP)

(72) Inventors: Linda Anne Leonard, Bloomfield Hills, MI (US); Emily Anne Curtis, Nashville, TN (US); Michael Bard, Wadern (DE)

(73) Assignee: Central Glass Company, Limited, Ube-shi, Yamaguchi (JP)

(21) Appl. No.: 17/762,436

(22) PCT Filed: Sep. 21, 2020
(86) PCT No.: PCT/US20/51770

§ 371 Date: Mar. 22, 2022

Related U.S. Application Data
(60) Provisional application No. 62/904,112, filed on Sep. 23, 2019.

(51) Int. Cl. B60J 1/00; B32B 7/12; B32B 17/10; B60K 35/00

(52) U.S. Cl. CPC B60J 1/001; B32B 7/12; B32B 17/10036; B32B 17/10678; B60K 35/00; B32B 2605/006; B32B 2307/71; B60J 3/007

(57) ABSTRACT

A vehicle glazing according to this disclosure comprises a glass sheet or glass sheets, and an ultraviolet light sensor for sensing an amount of ultraviolet light transmitted through the glass sheet or sheets. The ultraviolet light sensor may be provided on a glass surface as to receive light transmitted through at least one of the glass sheets and may be formed with an indicator showing information of the interior UV status.

### CROSS REFERENCE TO RELATED APPLICATION

This application claims priority to U.S. Provisional Patent Application No. 62/904,112 filed on Sep. 23, 2019, entitled “VEHICLE GLAZING,” the entire contents of which are incorporated by reference herein in their entirety.

### TECHNICAL FIELD

The present disclosure generally relates to a vehicle glazing having an ultraviolet light sensor for providing information to a driver or passenger.

### BACKGROUND

Ultraviolet (UV) light exposure is a concern to consumers wary of health concerns associated with exposure to UV light, including the threat of skin cancer and other adverse health effects induced by UV radiation such as sunburn, inflammatory disorder, or conjunctivitis. Thus, it is desirable to limit such exposure. UV light, however, may transmit through barriers between solar radiation and the driver and passengers, including glass windows. In certain applications, including automotive and architectural glass products, UV blocking or absorbing materials may be used to prevent such UV exposure, however, it may not be detectable by an observer.

### SUMMARY OF THE DISCLOSURE

Disclosed herein is a laminated vehicle glazing comprising a first glass sheet having opposing surfaces S1 and S2, a second glass sheet having opposing surfaces S3 and S4, the surface S2 facing the surface S3, an interlayer provided between the first and second glass sheets and a first ultraviolet light sensor. The ultraviolet light sensor may be provided on any surface of S2 through S4. The ultraviolet light sensor may be arranged as embedded between the interlayer and the glass sheet or attached to the interior surface S4 of the laminated vehicle glazing. The ultraviolet light sensor may operate together with an indicator for displaying an amount of ultraviolet light radiation. The indicator may be arranged between the interlayer and the glass sheet in the same way as the ultraviolet light sensor, or may be provided separately from the sensor, such as in a way as to be built in a dashboard or instrumental panel.

In some embodiments, a second ultraviolet light sensor may be provided.

The information regarding ultraviolet light radiation may be displayed as a graphic, which may be formed of colors, images, numerical values, or combinations of those.

In another aspect of this disclosure, a vehicle glazing includes a first glass sheet having opposing surfaces S1 and S2, the surface S1 on a vehicle external side and the surface S2 on a vehicle internal side, and an ultraviolet light sensor.

According to the disclosure, the vehicle glazing may be made for any of windshields, sunroofs, side glasses, and other vehicular glass parts.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations:

FIG. 1 illustrates a cross section view of a laminated glazing, according to exemplary embodiments of the present disclosure;

FIG. 2 illustrates a cross section view of a laminated glazing, according to exemplary embodiments of the present disclosure;

FIG. 3 illustrates a cross section view of a laminated glazing, according to exemplary embodiments of the present disclosure;

FIG. 4 illustrates a cross section view of a laminated glazing, according to exemplary embodiments of the present disclosure;

FIG. 5 illustrates a cross section view of a glazing, according to exemplary embodiments of the present disclosure;

FIG. 6 illustrates a front view of an indicator displaying information of a numerical value of ultraviolet light radiation, according to exemplary embodiments of the present disclosure;

FIG. 7 illustrates a schematic view showing color change of another indicator, according to exemplary embodiments of the present disclosure;

FIG. 8 illustrates a front view of yet another indicator displaying graphical levels of ultraviolet light radiation, according to exemplary embodiments of the present disclosure;

FIG. 9 illustrates a front view of an instrumental panel of a vehicle, according to exemplary embodiments of the present disclosure;

FIG. 10 illustrates a front view of further another indicator displaying information of numerical values of ultraviolet light radiation, according to exemplary embodiments of the present disclosure;

FIG. 11 illustrates a front view of a display showing a predicting message, according to exemplary embodiments of the present disclosure; and

FIG. 12 illustrates a vehicle glazing system for informing ultraviolet light radiation, according to exemplary embodiments of the present disclosure.

### DETAILED DESCRIPTION

Among other aspects, the present disclosure relates to a glazing for use in a vehicle which may include an ultraviolet light sensor. Particularly, the vehicle glazing may be for any suitable application, preferably an exterior facing glazing, such as a windshield, side window, back window, or sunroof. In the following description, for purposes of explanation, specific details are set forth in order to promote a thorough understanding of one or more aspects of the disclosure. It may be evident in some or all instances, however, that many aspects described below can be practiced without adopting the specific design details described below.

As used herein, the term “S1” may refer to the exterior glass sheet surface in an automotive glass construction. The term “S4” may refer to the interior glass sheet surface of a laminated automotive product having two glass sheets. The term “S2” may be a glass sheet surface opposite S1, and the term “S3” may be a glass sheet surface opposite S4. In a laminated glazing, the surface S2 and S3 may be a part of the laminate interior, facing each other and sandwiching an interlayer. In a non-laminated glazing having one glass sheet, S2 may be an interior facing glass sheet surface.

Vehicle glazings may include various protections against ultraviolet (UV) light radiation. For example, UV blocking coatings and/or interlayers may block UV radiation from reaching a vehicle interior. As used herein, UV blocking may include any effects to decrease UV radiation transmitted from a vehicle exterior to a vehicle interior though a vehicle glazing, including reflecting, absorbing, or scattering UV radiation, and/or combinations thereof. A glazing may preferably include one or a combination of UV blocking materials to protect a vehicle interior from UV light exposure.

In some glazings, a U V light blocking property may be formed from a UV blocking coating or adhering a UV blocking film to an exterior or interior surface of a glass sheet. A UV blocking coating may be made by application of one or more organic resin and/or inorganic materials having ultraviolet blocking, including scattering or absorbing, agents therein. A UV blocking coating may be formed with any suitable process, including a sol-gel process, and may include, for example, a silicon alkoxide containing a UV blocking agent(s). For example, without limitation, a coating base may be a silicon dioxide-based material, which may optionally be sintered from a binder containing tetra-alkoxysilane, tri-alkoxysilane, or combinations thereof. In some embodiments, the coating may further include a polymer resin, such as epoxy, silicone, vinyl ester, polyvinyl butyral, polyvinyl alcohol, urethane, or combinations thereof. In some example coatings, a UV blocking agent(s) may be provided in an amount as to be 5 to 20% by mass of the UV blocking coating. Further, a top protective coating may be added on a UV blocking coating to protect the coating during handling of a glass sheet and/or from environmental elements to which the coating may be exposed. Any suitable coating method may be used, including spin, flow, or spray coating methods.

The UV blocking agents are not particularly limited, but may include, for example, an organic UV blocking (absorbing) agent, such as a benzophenone-containing compound, a benzotriazole-containing compound, or a triazine-containing compound, or an inorganic UV blocking (scattering and/or absorbing) agent, such as platinum particles, zinc oxide particles, titanium oxide particles (preferably rutile structure), or cerium oxide particles.

Benzotriazole-containing compounds may include, for example, 2-(5-chloro-2-benzotriazolyl)-6-tert-butyl-p-cresol, 2-(5-methyl-2-hydroxyphenyl)benzotriazole, 2-[2-hydroxy-3,5-bis(α,α′-dimethylbenzyl)phenyl]-2l-benzotriazole, 2-(3,5-di-t-butyl-2-hydroxyphenyl)benzotriazole, 2-(3-t-butyl-5-methyl-2-hydroxyphenyl)-5-chlorobenzotriazole, 2-(3,5-di-t-butyl-5-methyl-2-hydroxyphenyl)-5-chlorobenzotriazole, 2-(3,5-di-t-amyl-2-hydroxyphenyl)benzotriazole, and 2-(2′-hydroxy-5′-t-octylphenyl)benzotriazole. Benzophenone-containing compounds may include, for example, 2-hydroxy-4-methoxybenzophenone, 2,2′-dihydroxy-4-methoxybenzophenone, 2-hydroxy-4-methoxy-2-carboxybenzophenone, and 2-hydroxy-4-n-octoxybenzophenone. Triazine-containing compounds may include, for example, 6-(4-hydroxy-3,5-di-t-butylanilino)-2,4-bis-octylthio-1,3, 5-triazine, 6-(4-hydroxy-3,5-dimethylanilino)-2,4-bis-octylthio-1,3,5-triazine, 6-(4-hydroxy-3-methyl-5-t-butylanilino)-2,4-bis-octylthio-1,3,5-triazine, and 2-octylthio-4,6-bis-(3,5-di-t-butyl-4-oxyanilino)-1,3,5-triazine. These UV blocking agents may be used alone or in a combination of two or more agents.

A UV blocking film may typically be formed having a base layer, an intermediate resin layer, and an adhesive layer. The base layer may include any suitable material, such as polyethylene terephthalate (PET), polycarbonate (PC), polyurethane (PU), polystyrene (PS), cellulose triacetate (TAC), or others. The intermediate resin layer may contain a UV blocking agent(s), as described above. The UV blocking agent(s) may be provided in an amount to provide 5 to 20% by mass of the intermediate resin layer. The adhesive layer preferably may be a resin that transmits visible light but is not particularly limited and may include an acrylic adhesive.

In some glazings, another method to obtain a UV light blocking property is to provide an interlayer with UV blocking agents between the glass sheets. The interlayer may include a polymer adhesive material, such as polyvinyl butyral (PVB) or ethylene vinyl acetate (EVA), having inorganic functional fine particles dispersed within the interlayer material which may preferably be evenly distributed within the interlayer. In other embodiments, organic UV-blocking agents may be dissolved in the interlayer material. An interlayer may include one or more UV blocking agents. The UV blocking agents may be provided in the interlayer with an area density of preferably 0.1 g/m² or more, more preferably 0.2 g/m² or more, and even more preferably 0.5 g/m² or more. Preferably, the UV blocking agents are provided in the interlayer with a density of 10 g/m² or less, more preferably 9 g/m² or less, and even more preferably 8 g/m² or less. Preferably, the UV blocking agents may be provided in the interlayer such that the UV blocking agents are 0.1% or more by mass of the interlayer, more preferably at least 0.5% or more by mass. Preferably, the UV blocking agents may be 5% or less by mass of the interlayer, more preferably 4% or less by mass. The interlayer may further include other functional agents such as infrared ray blocking agents.

Further, in some embodiments, either or both of the first and second glass sheets may be UV blocking. Such a UV blocking glass is not particularly limited where the glass blocks UV light and remains transparent to light in the visible range, wherein known UV blocking glass may be used. The preferable level of visible light transparency of the UV blocking glass may depend on the applicable glazing usage, such as whether a vehicle glazing is used as a windshield or a sunroof. UV blocking glass may include, for example, soda-lime glass which includes iron oxide and/or titanium oxide.

Passengers and drivers may benefit from understanding how much UV light is blocked from a vehicle interior and/or the UV exposure in a vehicle. This information to a passenger or driver may portray the UV light intensity and index. As such, it may be beneficial to include a UV light sensor in or on a vehicle glazing to provide such UV exposure information to a vehicle driver or passenger. Particularly, a UV sensor may operate to indicate UVA and UVB light, in a light wavelength range of from about 280 nm to about 400 nm.

It may be preferable to provide a glazing having a UV sensor for informing a driver and/or passenger about UV exposure information in or around a vehicle. The UV sensor may be oriented to provide information related to a vehicle interior, a vehicle exterior, and/or to provide information regarding the UV blocking of a glazing. The UV sensor provide information with an indicator for displaying information to the driver and/or passenger regarding the U V exposure at the UV sensor. Such an indicator may be formed with the UV sensor or otherwise collect information, such as wirelessly or through a wired connection, from the UV sensor. In some embodiments, it may be preferable to use the UV sensor to provide a user information about how much UV light is blocked by a glazing. In some embodiments, the UV sensor may preferably provide information about a vehicle interior's UV exposure which may change based on vehicle conditions, such as opening and closing windows. In some still further embodiments, UV sensors may be used to provide both information about UV light blocked by a glazing and how much UV light is in an interior vehicle space.

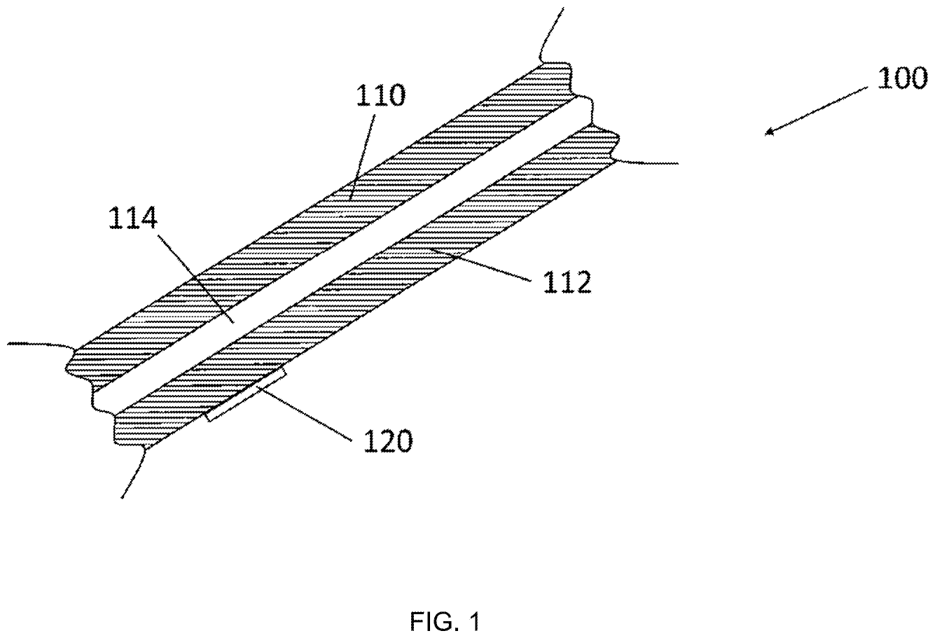

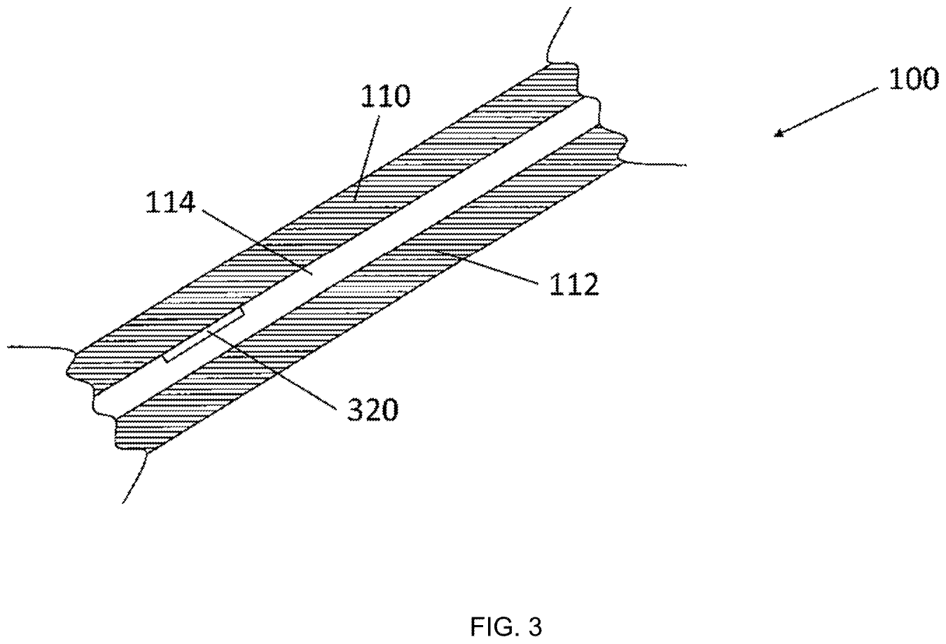

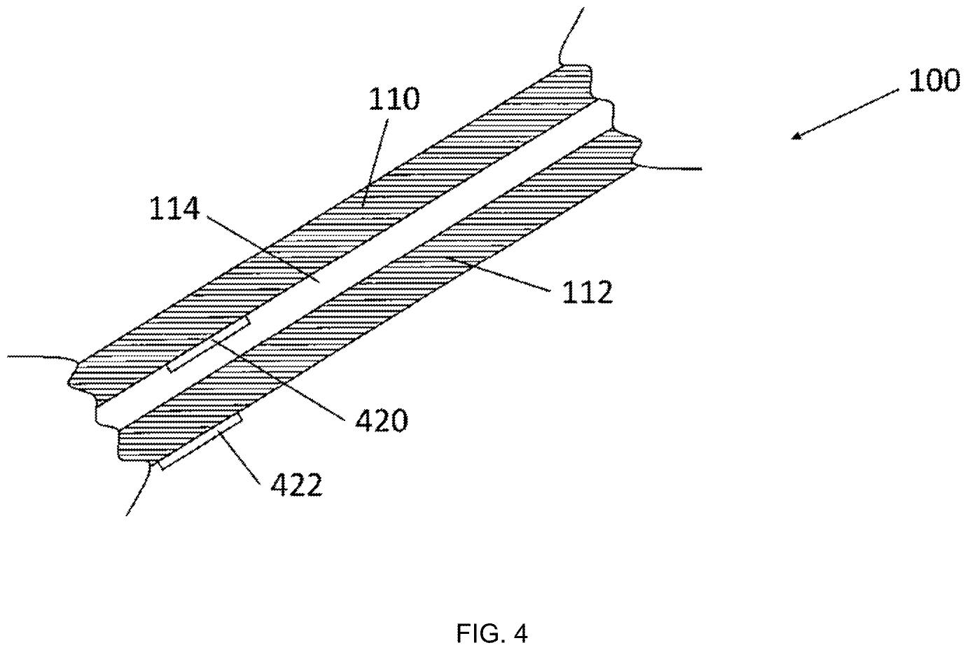

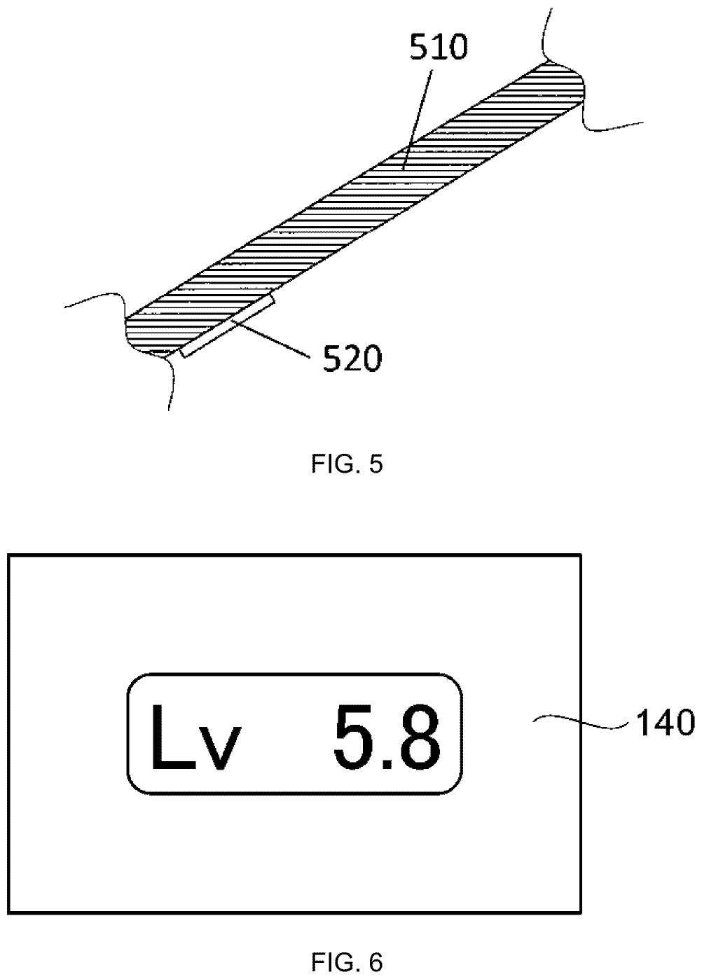

In some particular embodiments, a UV sensor 120 may be on an interior glass surface, as shown in FIG. 1. The UV sensor 120, 220, 320, 420, 422, 520 may be used on a laminated glazing 100 or a non-laminated glazing 510 as illustrated in FIGS. 1 to 5. The laminated glazing 100 may include a first glass sheet 110 and a second glass sheet 112 laminated together with an adhesive interlayer 114 therebetween. Particularly, an adhesive interlayer 114 may include an adhesive polymer, such as polyvinyl butyral (PVB) or ethylene vinyl acetate (EVA). A UV sensor 120, 422, 520 may be placed on an interior surface of the glazing, including surface S2 or S4 depending on the glazing structure. The UV sensor 120, 422, 520 may be adhered to the glazing 100, 510 with any suitable adhesive. Particularly, the adhesive for attaching a UV sensor 120, 422, 520 may include a pressure sensitive adhesive or a heat-cured adhesive. In some embodiments, the UV sensor adhesive may not be permanent such that the UV sensor 120, 422, 520 may be replaceable. For example, some UV sensors may lose effectiveness overtime, and it may be desirable to be able to replace such sensors, however, other UV sensors may not require such replacement. In some further embodiments, the UV sensor adhesive may be permanent. Where the UV sensor 120, 422 is attached to a laminated glazing 100, the UV sensor 120, 422 may be adhered to the glass sheet 112 before or after lamination of the glazing 100.

A UV sensor 120, 220, 320, 420, 422, 520 to be used herein may be work passively or require a power source. Where a UV sensor 120, 220, 320, 420, 422, 520 requires a power source, that source may be any suitable power connection to the UV sensor 120, 220, 320, 420, 422, 520.

Some embodiments may include a battery-powered UV sensor which may include replaceable batteries. Further, some embodiments may include a connected UV sensor that is connected to a power source by a wire or other suitable means. A solar cell may be used in some embodiments to provide such power for a UV sensor.

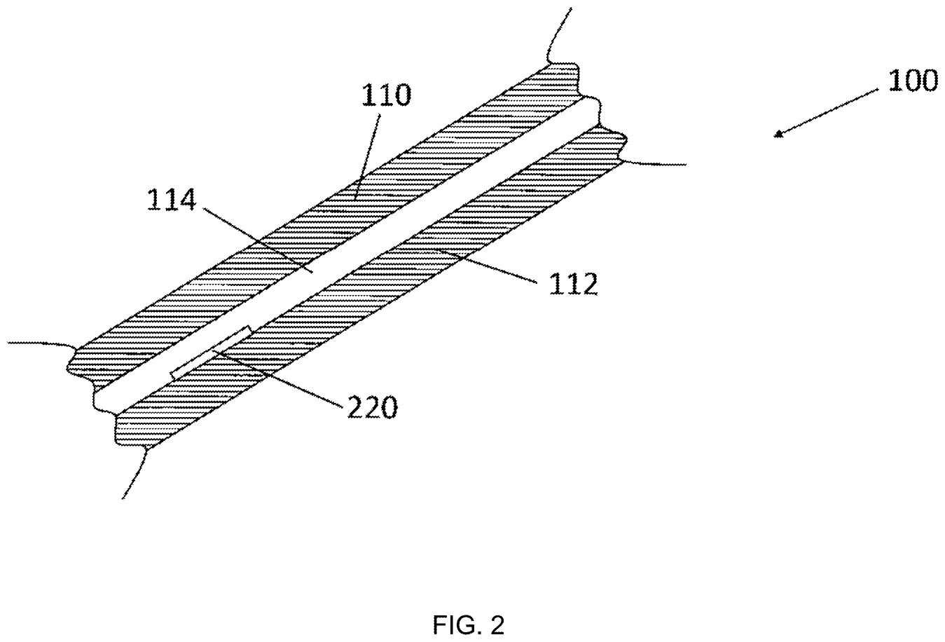

In some embodiments, as shown in FIGS. 2, 3, and 4, the UV sensor 220, 320, 420 may be laminated within a glazing 100. Where the UV sensor 220, 320, 420 is laminated in a glazing 100, the UV sensor 220, 320, 420 may be positioned between an interlayer 114 and either one of the glass sheets 110, 112. In some embodiments a UV sensor 220, 320, 420 which is laminated in a glazing 100 may be laminated between two interlayers. It may be preferable in certain embodiments that a second interlayer between the UV sensor 220, 320, 420 and a glass sheet may be a thin adhesive layer, having a smaller thickness than the other interlayer.

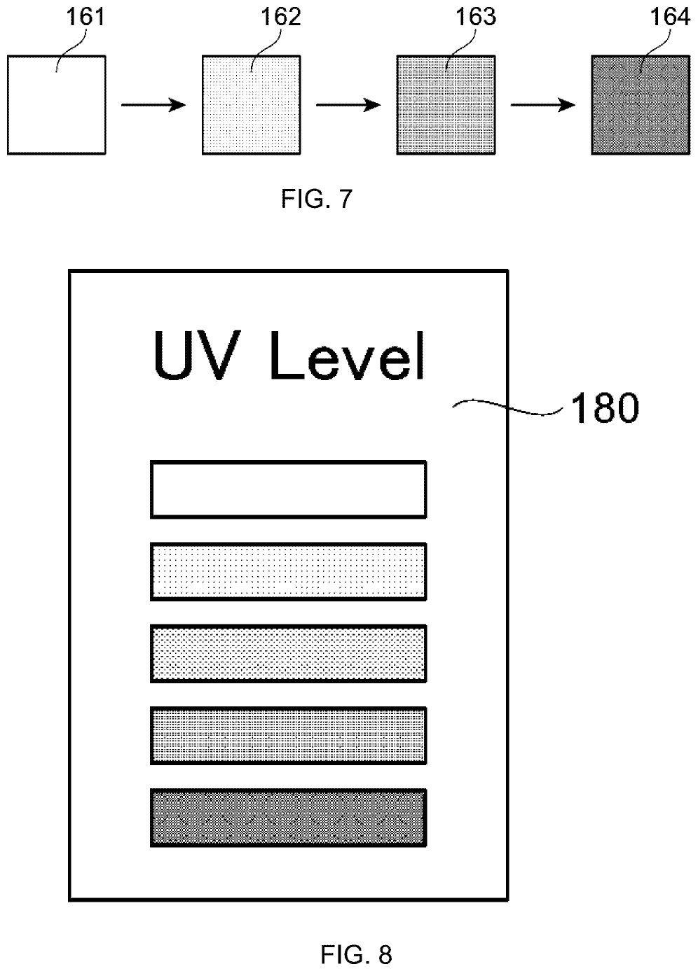

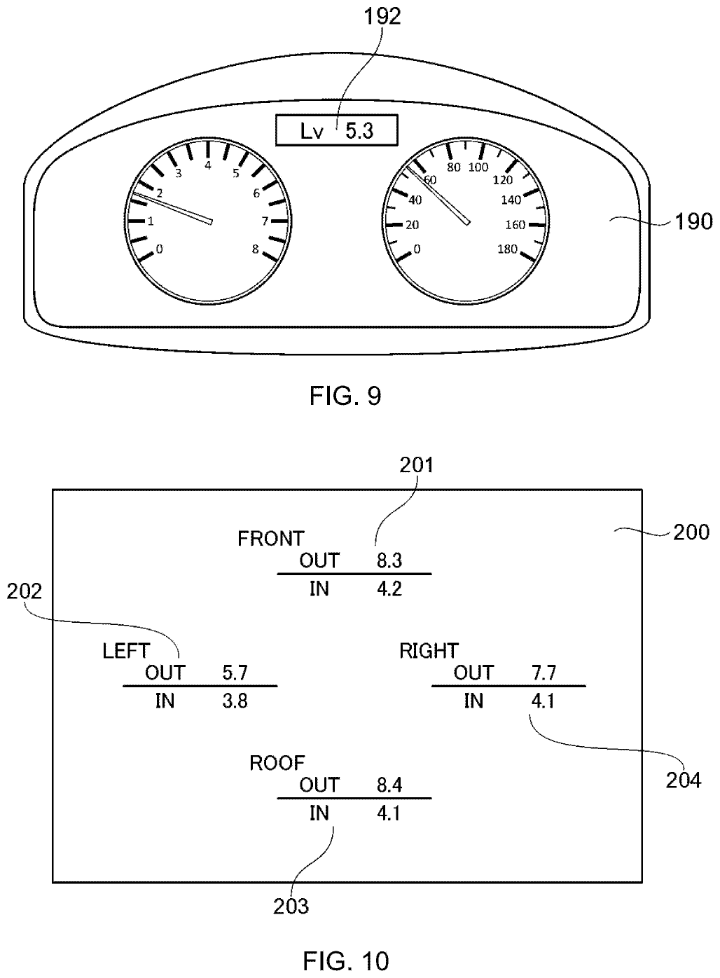

In some embodiments, the UV sensor 120, 220, 320, 420, 422, 520 may provide information to display such that a driver or passenger may understand their UV exposure in a vehicle. The display, or indicator, may provide information in any suitable form, including a graphical representation of the sensor's UV exposure. The graphic may include a color, image, numerical figures, or combinations thereof in some embodiments. FIG. 6 shows an indicator 140 displaying a numeral value of “Lv 5.8.” The number may be set as a relative scale and may, for example, be based on a UV light intensity, measured as mJ/cm², reaching the UV sensor. The indicator 140 may be electrically connected to a controller of this sensor system, which may receive an electrical signal from the UV sensor(s). Further displays may include instructional information for a user which may include recommended action based on UV radiation and/or information indicating how to interpret the display. Where a display gives information on a scale, the instruction for understanding such a scale may be included. Such instructional information may be static or variable based on the UV sensor 120, 220, 320, 420, 422, 520 measurements. For example, a UV sensor 320, 420 measuring an external UV exposure may indicate to a passenger or driver instructions for necessary protective measures when they exit the vehicle. In some embodiments, the display or indicator may be formed with the sensor 120, 220, 320, 420, 422, 520. For example, the sensor 120, 220, 320, 420, 422, 520 may change color to display the UV exposure information. FIG. 7 shows a color change from 161 to 164 in a UV sensor 120, 220, 320, 420, 422, 520 where the lighter color 161, 162 may show less blocking while the darker color 163, 164 may show more blocking. The change in color may be realized with the use of chemical compounds responsive to exposure to the UV light such as UV photochromic compounds. Such a UV sensor 120, 220, 320, 420, 422, 520 may be structured with a UV responsive compound coating or film and may be used without any wiring to the UV sensor 120, 220, 320, 420, 422, 520. In some embodiments, a suitable amount of UV photochromic crystal fine particles may be dispersed in a base film for a UV sensor. In some embodiments, a UV photochromic thin glass film may be used including soda-lime or borosilicate glass containing silver halide, such as silver chloride (AgCl). In other embodiments, the indicator may be formed separate from the UV sensor 120, 220, 320, 420, 422, 520. For example, the UV sensor 120, 220, 320, 420, 422, 520 may be connected electronically to an indicator which may provide UV radiation information to a user. In certain embodiments, the indicator may be separate from the glazing 100, 510 which includes the UV sensor 120, 220, 320, 420, 422, 520. The display may, for example, be provided in a vehicle dash or head-up display. The UV sensor 120, 220, 320, 420, 422, 520 may collect UV data which may be transmitted to an indicator or display. FIG. 8 shows a level meter 180 indicating level height representing the UV level of the vehicle interior. The level meter 180 may be provided at an instrumental panel, a dashboard, or any suitable place observable by a driver or passenger. FIG. 9 shows an example of an instrument panel 190 with a built-in indictor 192. The built-in indicator 192 may be formed solely for indicating the UV levels and also may use software programming with a monitor to display UV data. Information provided by the indicator 192 may be transmitted from a UV sensor 120, 220, 320, 420, 422, 520 through a physical connection in the vehicle or wirelessly. Displays may further be provided on smart devices, such as a phone or tablet, where UV data may be transmitted wirelessly to such devices.

In FIG. 10, a panel 200 serving as an indicator for the UV sensor indicates information of interior and exterior UV environments at four portions of the vehicles, according to an example of this disclosure. The four portions of the vehicle glazings may be front (windshield) 201, left (side window) 202, right (side window) 204, and roof (sunroof) 203. Each portion may include the exterior UV level information (OUT) and/or the interior UV level information (IN). The interior UV level information is represented by a numerical value showing the sun blocking effect of the vehicle glazing. Such a panel 200 may collect information for display from more than one UV sensor. In some examples, there may be at least one UV sensor for each portion of the panel 200. Where UV sensors are used for determining interior and exterior information about UV exposure, a percentage of UV blocking by a glazing may be calculated and displayed to a user.

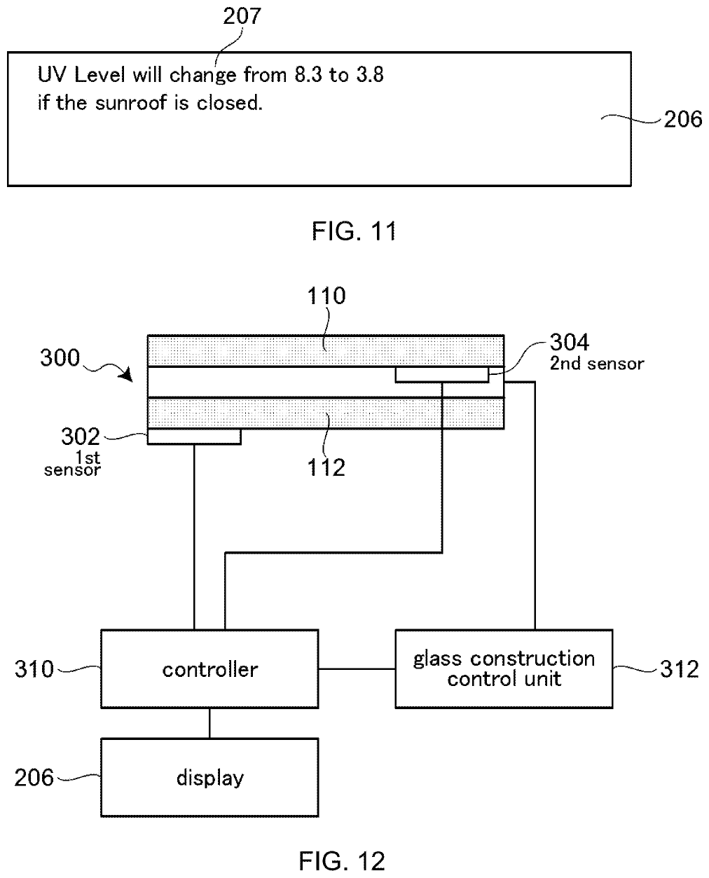

The display of information from a UV sensor may provide a predictive model for a user, such as indicating a change in the environment based on a mechanical change in the car, such as opening or closing a window. FIG. 11 shows an example of a message 207 on a display 206 according to this disclosure. The message 207 in FIG. 11 indicates a suggestion and prediction when a functional glass is controlled. The prediction may be calculated at the controller of the system, using known UV absorption and reflection values of the functional glass construction. Where a functional glass construction 300, the functional glass construction 300 may be operable to switch between an open position and a closed position, as controlled by a glass construction control unit 312, which may be connected to a switch for control by a user as shown in FIG. 12. The glass construction control unit 312 may provide a signal to the controller 310 to indicate whether the functional glass construction 306 is in an open state or a closed state. The controller 310 may use the information about the functional glass construction 306 and information from first and second UV sensors 302, 304 to send an appropriate signal to a display 206. The first UV sensor 302 may be a sensor detecting the amount of UV exposure in an environment inside the functional glass construction 300, while the second UV sensor 304 may detect the exterior UV environment. With use of the first and second sensors 302, 304, the controller 310 may provide suggestive messages to the display 206, which may provide information for drivers and/or passengers to evaluate their environment within the vehicle. In some embodiments, a glass structure may include a switchable film, such as an electrochromic film, which may be connected to a controller 310 connected to UV sensors for providing a display which may provide a prediction about a UV condition in response to a change in the opacity of the electrochromic film.

In particular embodiments, the UV sensor 120, 220, 320, 420, 422, 520 may be preferably provided in or on a windshield or a sunroof. In further embodiments, it may be preferable to provide the UV sensor 120, 220, 320, 420, 422, 520 on a side window. The UV sensor 120, 220, 320, 420, 422, 520 may be in any suitable form to collect UV light information. The UV sensor 120, 220, 320, 420, 422, 520 may be passive or electronic, for example. A passive UV sensor may be provided as an adhesive patch or film which may be attached to a glass surface. In some embodiments, the UV sensor 120, 220, 320, 420, 422, 520 may be transparent. Where the UV sensor 120, 220, 320, 420, 422, 520 is provided on a glazing having a coating, it may be preferable that the UV sensor 120, 220, 320, 420, 422, 520 align with the coating such that the UV sensor 120, 220, 320, 420, 422, 520 may not align with any deletions which may be formed in the coating, including an infrared reflective coating.

A UV sensor 120, 220, 320, 420, 422, 520 may be non-directional such that information may be collected from an interior and/or an exterior space when the UV sensor 120, 220, 320, 420, 422, 520 is installed or directional such that the orientation of the UV sensor 120, 220, 320, 420, 422, 520 may determine what information is collected. The desired information to be gained with a UV sensor 120, 220, 320, 420, 422, 520 may determine a desirable orientation of the UV sensor 120, 220, 320, 420, 422, 520. Where it is desirable for a UV sensor 120, 220, 320, 420, 422, 520 to provide information about a vehicle interior, a directional UV sensor may be positioned to face a vehicle interior. In a further example, where it is desirable to display information about the UV radiation passing through a glazing, including any glass sheets and interlayers, it may be preferable to position the directional UV sensor on an interior glass surface, such as surface S4 in a laminated glazing and S2 in a tempered glass sheet. Information may be displayed to a user in the same direction the directional UV sensor faces or a different direction.

In the description above, for purposes of explanation and not limitation, the examples with specific details are set forth to provide a thorough understanding of the present disclosure. However, it will be apparent to those having ordinary skill in the art that other embodiments with various modifications and variations may be practiced without departing from the spirit and scope of the present disclosure.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A laminated vehicle glazing, comprising:
a first glass sheet having opposing surfaces S1 and S2;
a second glass sheet having opposing surfaces S3 and S4, the surface S2 facing the surface S3;
an interlayer provided between the first and second glass sheets; and
a first ultraviolet light sensor.

2. The laminated vehicle glazing according to claim 1, wherein the first ultraviolet light sensor is positioned on any one of the surfaces S2, S3, and S4.

3. The laminated vehicle glazing according to claim 1, wherein the laminated vehicle glazing is made for any one of a windshield, a sunroof, and a side window.

4. The laminated vehicle glazing according to claim 1, wherein the first ultraviolet light sensor provides information with an indicator for displaying information regarding ultraviolet light radiation.

5. The laminated vehicle glazing according to claim 4, wherein the information regarding ultraviolet light radiation is displayed as a graphic.

6. The laminated vehicle glazing according to claim 5, wherein the graphic comprises a color or colors.

7. The laminated vehicle glazing according to claim 5, wherein the graphic comprises an image.

8. The laminated vehicle glazing according to claim 5, wherein the graphic comprises a numerical value.

9. The laminated vehicle glazing according to claim 5, wherein the graphic includes more than one of a color, an image, and a numerical value.

10. The laminated vehicle glazing according to claim 5, wherein the graphic comprises a recommended action.

11. The laminated vehicle glazing according to claim 4, wherein the indicator is separated in space from a body of the first ultraviolet light sensor.

12. The laminated vehicle glazing according to claim 11, wherein the indicator is separated in space from the laminated vehicle glazing.

13. The laminated vehicle glazing according to claim 12, wherein the indicator is part of a dashboard of the vehicle.

14. The laminated vehicle glazing according to claim 1, further comprising a second ultraviolet light sensor.

15. The laminated vehicle glazing according to claim 14, wherein the second ultraviolet light sensor is positioned between a vehicle exterior and the interlayer.

16. The laminated vehicle glazing according to claim 1, wherein the first ultraviolet light sensor is positioned between a vehicle interior and the interlayer.

17. The laminated vehicle glazing according to claim 1, wherein the first ultraviolet light sensor is positioned to determine an amount of ultraviolet light passing through the first glass sheet, the interlayer, and the second glass sheet.

18. The laminated vehicle glazing according to claim 1, wherein the first ultraviolet light sensor is positioned to determine an amount of ultraviolet radiation in a vehicle interior.

19. The laminated vehicle glazing according to claim 1, wherein the first ultraviolet light sensor is positioned to determine an amount of ultraviolet radiation passing through the first glass sheet.

20. A vehicle glazing, comprising:
a first glass sheet having opposing surfaces S1 and S2, the surface S1 on a vehicle exterior side and the surface S2 on a vehicle interior side; and
a first ultraviolet light sensor.

21. The vehicle glazing according to claim 20, wherein the vehicle glazing is made for any one of a side window and a sunroof.

22. The vehicle glazing according to claim 20, wherein the first ultraviolet light sensor is positioned on the surface S2 of the first glass sheet.

23. The vehicle glazing according to claim 20, wherein the first ultraviolet light sensor is formed with an indicator displaying information regarding ultraviolet light radiation.
